(19) United States
(12) Patent Application Publication
(10) Pub. No.: US 2017/0066098 A1
(43) Pub. Date: Mar. 9, 2017

(54) CLAMPING JAW AND METHOD FOR MANUFACTURING A CLAMPING JAW

(71) Applicant: Röhm GmbH, Sontheim/Brenz (DE)

(72) Inventors: EDUARD SCHWEIGERT, SYRGENSTEIN (DE); JENS GRÄßLE, HEIDENHEIM (DE)

(21) Appl. No.: 15/253,167

(22) Filed: Aug. 31, 2016

(30) Foreign Application Priority Data
Sep. 3, 2015 (DE) 10 2015 114 710.6

(51) Int. Cl. B23Q 11/12; B33Y 80/00; B33Y 10/00; B25B 5/16; B23Q 3/06

(52) U.S. Cl. CPC B23Q 11/126; B25B 5/163; B23Q 3/06; B33Y 10/00; B33Y 80/00

(57) ABSTRACT

A clamping jaw for clamping or holding a workpiece is described. The clamping jaw includes a base body and a clamping contour, which is provided for abutment against a workpiece and can be cooled by a cooling device. The cooling device is implemented by at least one coolant duct, which is provided for receiving a coolant and which is formed in the base body by a generative production (e.g., additive manufacturing) process. The formation of the base body is free of auxiliary bores. Furthermore, a method for manufacturing a clamping jaw is described.

### CROSS-REFERENCE TO RELATED APPLICATIONS/INCORPORATION BY REFERENCE

This patent application makes reference to, claims priority to, and claims benefit from German Patent Application No. 10 2015 114 710.6, filed on Sep. 3, 2015. The above-identified application is hereby incorporated by reference herein in its entirety.

### FIELD OF THE DISCLOSURE

Some embodiments of the present disclosure relate to a clamping jaw that clamps or holds a workpiece. The clamping jaw can include, for example, a base body and a clamping contour, which is provided for abutment against a workpiece and can be cooled by a cooling device. Furthermore, some embodiments of the present disclosure relate to a method for manufacturing a clamping jaw.

### BACKGROUND

Limitations and disadvantages of conventional and traditional approaches will become apparent to one of skill in the art, through comparison of such systems with the present disclosure as set forth in the remainder of the present application with reference to the drawings.

### BRIEF SUMMARY

Systems, devices, and methods that provide a clamping jaw are provided, substantially as illustrated by and/or described in connection with at least one of the figures, as set forth more completely in the claims.

### BRIEF DESCRIPTION OF THE DRAWINGS

FIG. 1 shows a perspective view of an embodiment of a clamping jaw according to the present disclosure.

FIG. 2 shows a plan view of an embodiment of the clamping jaw according to the present disclosure.

FIG. 3 shows a sectional view of the clamping jaw along the section as shown in FIG. 2 according to the present disclosure.

FIG. 4 shows a rear view of an embodiment of the clamping jaw according to the present disclosure.

FIG. 5 shows a sectional view along the section V-V as shown in FIG. 4 according to the present disclosure.

### DETAILED DESCRIPTION

A variety of clamping jaws can be designed in a number of different ways as a function of the intended use. The term “clamping jaws” includes clamping jaws and other holding mechanisms, such as, for example, grippers or holding jaws. However, when clamping jaws are used, for example, in hard turning, metal cutting or laser cutting operations of workpieces, there is often a concern that the heat that is generated while machining the workpieces is conducted through the clamping jaws into the clamping mechanism and finally into the associated machining unit. As a result, the machining unit gets very hot, which can adversely affect its functionality. Furthermore, the increase in temperature also causes the workpiece that is to be machined, and the clamping jaw, to expand. The expansion results in larger production tolerances and a negative impact on the work result.

Some embodiments of the present disclosure provide a clamping jaw that clamps or holds a workpiece. The clamping jaw can include, for example, a base body and a clamping contour, which is provided for abutment against a workpiece and can be cooled by a cooling device. Furthermore, some embodiments of the present disclosure provide a method for manufacturing a clamping jaw.

Some embodiments of the present disclosure provide a clamping jaw that is cooled by a cooling device that can be implemented by at least one coolant duct. The at least one coolant duct is configured to receive a coolant and is formed in a base body of the clamping jaw by a generative production (e.g., additive manufacturing) process such that the base body is free of auxiliary bores. Auxiliary bores can cause local weakening which can have a negative impact on the mechanical stability of the base body of the clamping jaw.

This approach ensures that the heat that is generated in the course of machining a workpiece is effectively removed by the coolant in the coolant duct and leads to an improvement in the work result. Since the base body is manufactured by a generative production (e.g., additive manufacturing) process, it is possible to form the coolant duct immediately (or simultaneously or concurrently) during the production of the base body. When the base body is manufactured by a generative production (e.g., additive manufacturing) process, the region in which the coolant duct is supposed to run in the finished clamping jaw can be recessed. In addition, this technique allows the coolant ducts to run in any direction, and it is possible to dispense with the auxiliary bores in the base body. Auxiliary bores can have a negative impact on the mechanical load bearing capacity of the clamping jaw and render the production process more difficult because the auxiliary bores have to be closed again, which might require a great effort. In particular, this approach makes it possible to provide relatively small clamping jaws. Without this approach, an integration of a cooling device into the clamping jaw itself would not be possible due to stability and space reasons.

Some embodiments of the present disclosure provide that the coolant duct has at least one curved section. The use of a curved section makes it possible to improve (e.g., significantly improve) the flow behavior of the coolant, which, in turn, improves the heat removal.

Some embodiments of the present disclosure provide that the coolant duct includes a meander-shaped subsection, which increases cooling capacity. In an exemplary embodiment, the coolant duct can extend over the entire width and height of the base body, so that it is possible to achieve a cooling surface that is as large as possible, which has a positive impact on heat removal.

Some embodiments of the present disclosure provide that the run of the coolant duct is adapted to a clamping contour of the clamping jaw. In an exemplary embodiment of the clamping jaw, it is possible to shape the run of the coolant duct in any number of ways, so that the coolant duct can conform to the profile of the clamping contour. The profile of the clamping contour can be formed, for example, by a curved surface and does not have to be flat.

Some embodiments of the present disclosure provide that the wall thickness between the clamping contour and the coolant duct is less than the diameter of the coolant duct. This feature allows the clamping jaw to be cooled in the vicinity of the contour, ensuring that the generated heat is effectively removed. Some embodiments of the present disclosure provide that the diameter of the coolant duct be constant.

Some embodiments of the present disclosure provide that a coolant inlet and a coolant outlet be formed in the base body of the clamping jaw. This arrangement allows the coolant to be routed into or out of the clamping jaw to keep the coolant capacity constant. Some embodiments of the present disclosure provide that the coolant inlet and the coolant outlet are formed at the same time (or concurrently or simultaneously) as the base body during the generative production (e.g., additive manufacturing) process. Then the coolant lines can be connected to the coolant inlet and the coolant outlet in a simple way, for example, via a suitable plug or screw connection.

Some embodiments of the present disclosure provide that the coolant includes one or more of air, water and oil, for example. Air, water and oil provide a simple coolant that is cost-effective and that typically does not require additional infrastructural retrofitting. Of course, other types of coolants are also contemplated and fall within the scope of this disclosure.

Some embodiments of the present disclosure provide that the base body is made of metal. In addition to the associated stability of the clamping jaw, making the base body out of metal ensures effective thermal conduction between the workpiece to be machined and the coolant duct conducting the coolant, so that the generated heat is effectively removed. For example, the base body can be made of tool steel or any other suitable metals.

From a manufacturing viewpoint, it has also proved to be particularly advantageous if the base body is made of an alloy that includes aluminum, zinc, magnesium and copper, for example, as contemplated by some embodiments of the present disclosure. Such alloys exhibit high strength and, in addition, can also be used for manufacturing with the generative production (e.g., additive manufacturing) process. Some embodiments of the present disclosure provide that the base body can be made of other aluminum or titanium alloys as well as any other suitable alloys.

Some embodiments of the present disclosure provide for reducing the production costs and providing a method with which it is possible to manufacture a clamping jaw with high mechanical stability that can be cooled.

Some embodiments of the present disclosure provide a method that includes applying a material in layers in order to form a base body with the coolant duct being recessed, and simultaneously (or concurrently) forming a clamping contour.

Some embodiments of the method according to the present disclosure make it possible to design the coolant ducts in any number of ways; in particular, the coolant ducts can be adapted to the profile of the clamping contour. The layered application of the material, during which the coolant duct, located in the base body, is recessed, makes it possible to avoid in a simple way the auxiliary bores, which otherwise are usually used to design coolant circuits in solid bodies. Since the cooling ducts and the clamping contour are formed at the same time when the based body is made, there is no need for subsequent machining, save for any grinding operations. Such a production process has a positive impact on the production costs and the production time. Some embodiments of the method according to the present disclosure contemplate using different generative production techniques such as, for example, laser fusion or laser sintering or using a casting process.

In an exemplary embodiment, it has proved successful if the method further includes simultaneously incorporating a coolant inlet and a coolant outlet into the base body.

The simultaneous (or concurrent) incorporation of the coolant inlet and the coolant outlet into a single production step makes it possible to use the clamping jaw without any major subsequent machining operations. The single production step can be accomplished according to any of the methods or processes contemplated by the present disclosure.

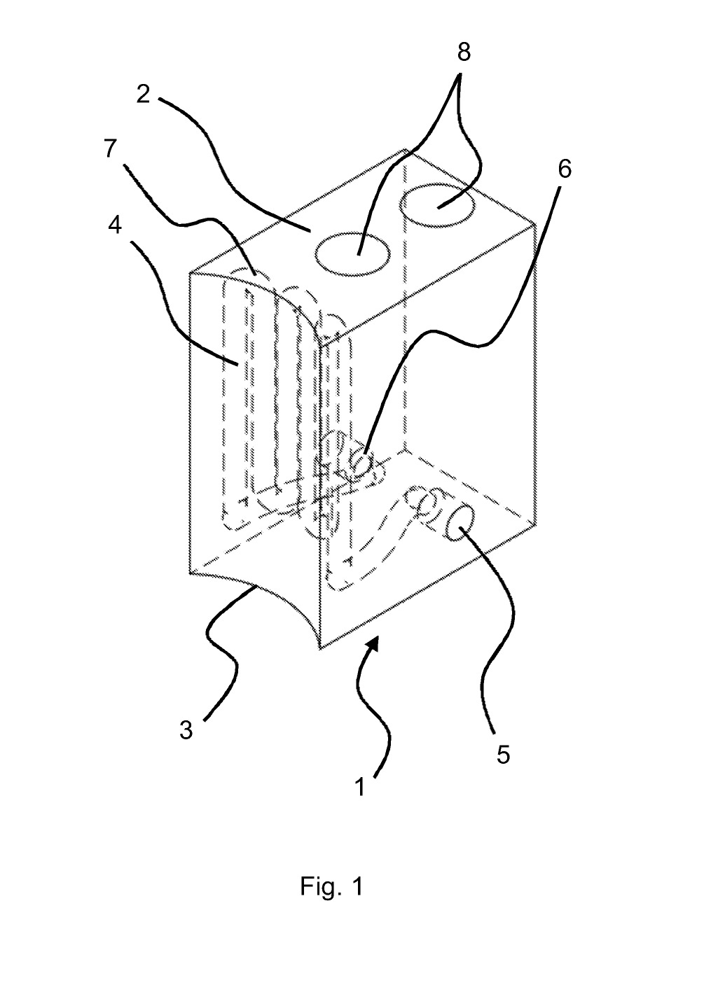

FIG. 1 shows an embodiment of a clamping jaw 1 that is provided for clamping or holding a workpiece according to the present disclosure. The clamping jaw 1 has a base body 2 and has, on one side, a clamping contour 3, which is formed in the shape of a circular (or curved) segment in the embodiment that is shown solely for illustrative purposes. As shown in FIG. 1 by the dashed lines, the base body 2 of the clamping jaw 1 has a coolant duct 4, which is defined by a coolant inlet 5 and a coolant outlet 6. In the exemplary embodiment shown, the coolant duct 4, which has a plurality of curved sections 7, conforms in a meandering manner to the profile of the clamping contour 3. In addition, receptacles 8 for receiving attachment mechanisms, with which the clamping jaw 1 can be attached to a suitable clamping mechanism, can be seen in the top side of the base body 2.

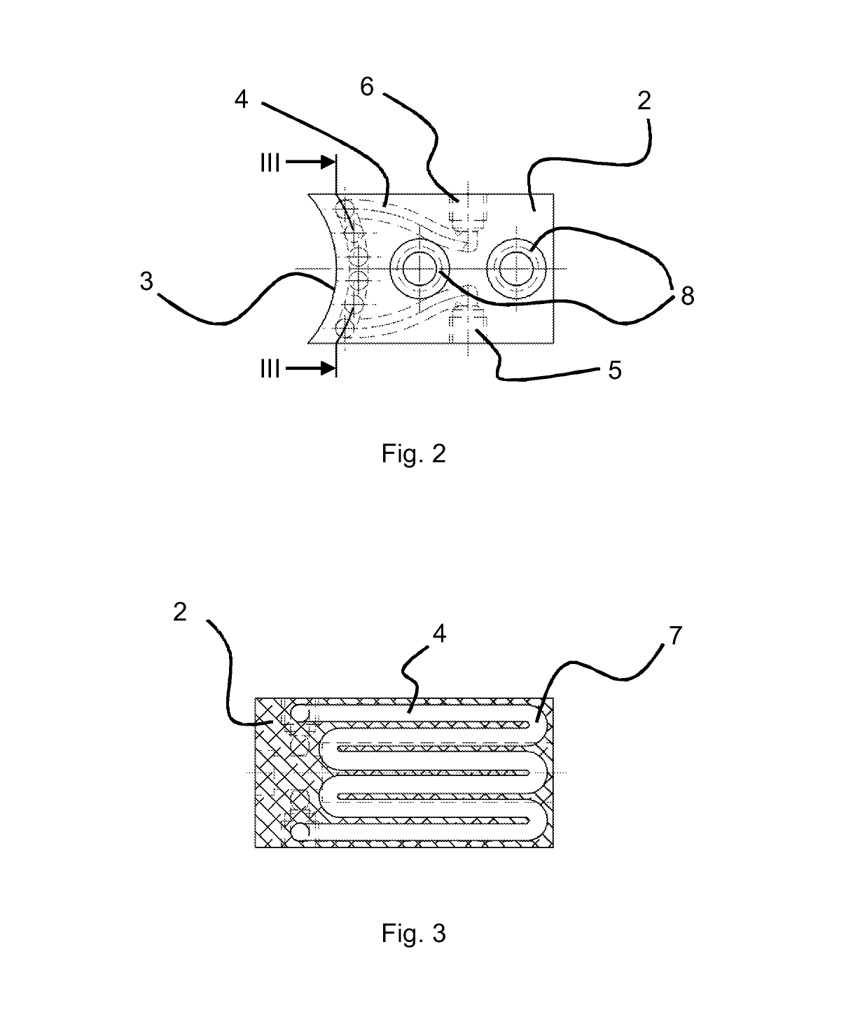

Referring to the plan view of the clamping jaw 1 shown in FIG. 2, the shape of the coolant duct 4 conforms to the shape of the clamping contour 3. In this exemplary embodiment, the distance between the coolant duct 4 and the clamping contour 3 is less than the diameter of the coolant duct 4, in order to achieve cooling that is as effective as possible.

FIG. 3 is a sectional view along the section as shown in FIG. 2. Referring to FIG. 3, the exemplary embodiment of the coolant duct 4 has a meandering shape that is made up of individual curved sections 7.

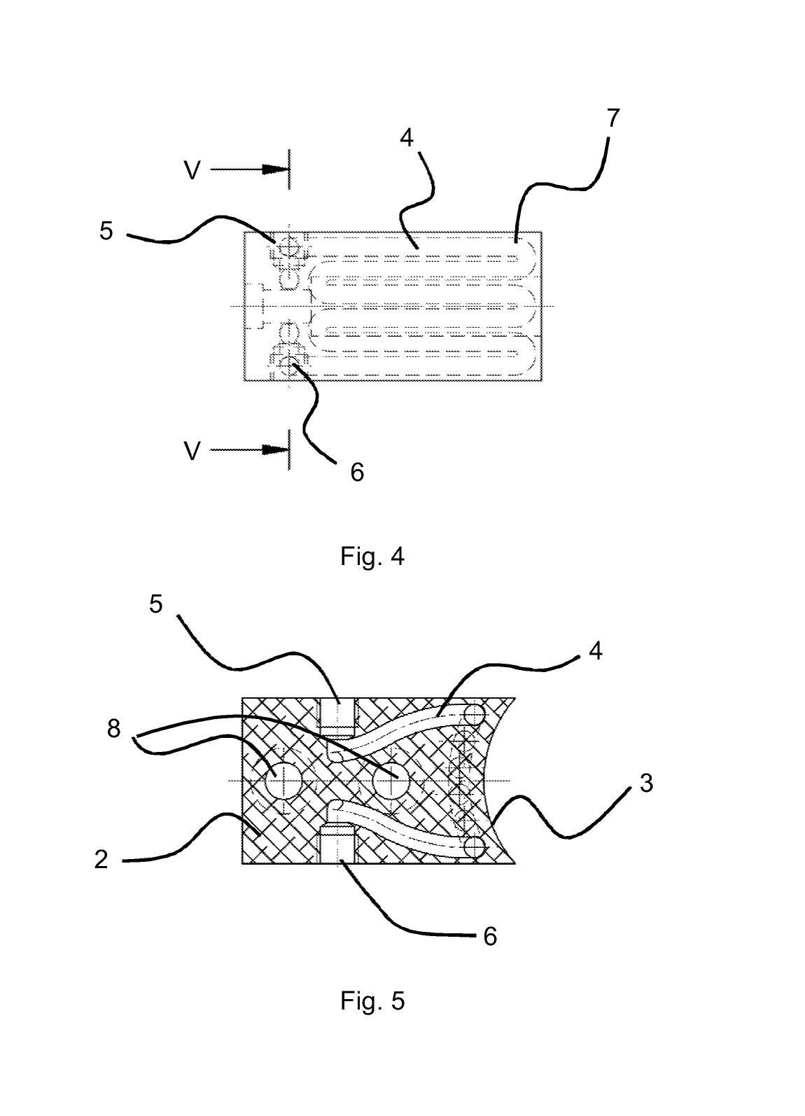

FIG. 4 shows a rear view of an embodiment of the clamping jaw 1. FIG. 5 shows a sectional view along the section V-V as shown in FIG. 4. FIGS. 4 and 5 show the positioning of the coolant inlet 5 and the coolant outlet 6. The coolant can be fed into or out of the coolant duct 4 through the coolant inlet 5 and the coolant outlet 6, respectively. In the exemplary embodiment that is illustrated, the base body 2 is made of metal, e.g., an alloy that includes aluminum, zinc, magnesium and copper. As an alternative, the base body 2 can also be made of a different aluminum or titanium alloy or tool steel.

Some embodiments of a method for manufacturing the clamping jaw 1 according to the present disclosure are further described. The base body 2 of the clamping jaw 1 is made by applying a material in layers on a suitable substrate in a generative production (e.g., additive manufacturing) process. In some embodiments, no material is applied at the points where the coolant duct 4 is to be formed later, so that the base body 2 is formed in layers next to the coolant duct 4. In some embodiments, suitable ports are recessed at the points at which the coolant inlet 5 and the coolant outlet 6 are provided, for example, during the production process, so that it is possible to dispense with a subsequent machining of the generatively-produced base body 2. The clamping contour 3 is formed at the same time that the clamping jaw 1 is manufactured. In an exemplary embodiment, the individual layers are made by laser sintering.

### LIST OF REFERENCE NUMERALS

| | |
|---|---|
| 1 | clamping jaw |
| 2 | base body |
| 3 | clamping contour |
| 4 | coolant duct |
| 5 | coolant inlet |
| 6 | coolant outlet |
| 7 | curved section |
| 8 | receptacle |

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A clamping jaw for clamping or holding a workpiece, comprising:
a base body; and
a clamping contour that is configured to provide an abutment against a workpiece and that is cooled by one or more coolant ducts, wherein the one or more coolant ducts are configured to receive a coolant and are formed in the base body by a generative process.

2. The clamping jaw of claim 1, wherein the base body is free of auxiliary bores.

3. The clamping jaw of claim 1, wherein the one or more coolant ducts and the base body are concurrently formed by the generative process.

4. The clamping jaw of claim 1, wherein the one or more coolant ducts have at least one curved section.

5. The clamping jaw of claim 1, wherein the one or more coolant ducts includes a meander-shaped subsection.

6. The clamping jaw of claim 1, wherein a run of the one or more coolant ducts is adapted to the clamping contour.

7. The clamping jaw of claim 1, wherein a wall thickness between the clamping contour and one of the one or more coolant ducts is less than the diameter of the one coolant duct.

8. The clamping jaw of claim 1, wherein a coolant inlet and a coolant outlet are formed in the base body.

9. The clamping jaw of claim 1, wherein the coolant includes one or more of air, water, and oil.

10. The clamping jaw of claim 1, wherein the base body is made of a metal.

11. The clamping jaw of claim 1, wherein the base body is made of an alloy that includes aluminum, zinc, magnesium, and copper.

12. The clamping jaw of claim 1, wherein the generative process includes applying a material in layers to form the base body with the one or more coolant ducts being recessed, and forming the clamping contour.

13. The clamping jaw of claim 12, wherein the generative process concurrently forms the base body, the one or more coolant ducts, and the clamping contour.

14. The clamping jaw of claim 1, wherein the generative process includes forming a coolant inlet and a coolant outlet.

15. The clamping jaw of claim 1, wherein the forming of the coolant inlet and the coolant outlet occurs during the formation of the base body.
